(19) United States
(12) Patent Application Publication
(10) Pub. No.: US 2004/0050716 A1
(43) Pub. Date: Mar. 18, 2004

(54) Electrochemical oxidation of matter

(76) Inventors: Christopher Peter Jones, Wiltshire (GB); Dominic John Kieran, Surrey (GB); Linda Jane McCausland, Oxfordshire (GB); Patrick Alan Fletcher, Wiltshire (GB); Patrick Wakefield Nevins, Oxfordshire (GB); David Frame Steele, Caithness (GB); Andrew Derek Turner, Oxfordshire (GB); Stuart Anton Legg, Berkshire (GB)

Correspondence Address: William H Holt, Unit 2 First Floor, 1423 Powhatan Street, Alexandria, VA, 22314, US

(21) Appl. No.: 10/470,553

(22) PCT Filed: Jan. 23, 2002
(86) PCT No.: PCT/GB02/00262

(30) Foreign Application Priority Data
Feb. 2, 2001 (GB) 0102648.3

(51) Int. Cl. C02F 1/461

(52) U.S. Cl. 205/742

(57) ABSTRACT

In apparatus for decomposing organic waste by oxidation using electrochemically regenerated Ag++, provision is made for preventing unwanted carryover of organic material into recovery streams and into any solid waste produced by the apparatus. Gases formed in the processing are also treated to prevent or minimise any carryover of toxic components in gaseous effluent from the apparatus.

The invention relates to methods and apparatus for the electrochemical oxidation of matter and has particular application in the decomposition of waste material comprising organic compounds which may contain metals (including Arsenic), sulphur, nitrogen, phosphorus and/or halogen.

Patent specification EP 0 297 738 describes a method and apparatus for electrochemical treatment of organic waste matter using an aqueous electrolyte comprising nitric acid and containing silver ions as an electrochemically re-generable primary oxidising species. Operated at a temperature between 50° C. and 90° C., the cell is particularly effective in decomposing organic waste matter.

Patent specification EP 0 771 222 describes developments of the apparatus of EP 0 297 738 for preventing or reducing the build-up of contamination of electrolyte by one or more of the elements sulphur, nitrogen, chlorine, bromine or iodine. Reference is made to organic waste which has assumed importance in recent years in the form of explosive material and chemical weapons required to be destroyed, for example, under International Treaty arrangements. Further examples of organic waste requiring destruction for which the method and apparatus has application are wastes containing agrochemicals (pesticides and herbicides) and toxic pharmaceuticals.

The method and apparatus described in these prior patent specifications provides a relatively safe and effective route for the disposal of such material and EP 0 771 222 addresses the problems of build-up of contamination in the electrolyte. Certain waste materials for disposal present additional hazards. The present invention is concerned with measures to protect against these, to improve overall environmental acceptability of the apparatus and reduce the possibilities for fouling of the electrochemical cell by solids in the electrolyte.

The invention provides, in one of its aspects, a method of treating waste matter comprising organic matter in which method an acidic aqueous electrolyte containing ions of silver as an electro-chemically re-generable primary oxidising species is subjected to an electric potential within an electro-chemical cell and the waste matter is added to the electrolyte either continuously or periodically thereby to be decomposed by an oxidation process in which the primary oxidising species is reduced and re-generated by the electric potential, characterised in that electrolyte is withdrawn for separation of unwanted matter and/or waste product therefrom and a treatment is applied which removes residual organic matter from the said unwanted matter and/or waste product. Typically, such treatment is a heat treatment carried out at at least 518° C. for a period of at least 15 minutes.

Alternatively, withdrawn is subjected to a further oxidation decomposition treatment, or a sequential plurality of further such treatments, by admixture with an acidic aqueous electrolyte containing ions of silver as an electrochemically re-generable primary oxidising species and subjected to an electric potential within an electrochemical cell for re-generation of the primary oxidising species which has been reduced in the oxidation decomposition reaction.

The said sequential plurality of further treatments may advantageously be carried out in a plug flow reactor or reactors.

Preferably the acidic aqueous electrolyte comprises nitric acid and said ions of silver.

Preferably, treatment is provided, for example using a catalytic oxidiser, for removing volatile organic compounds from any gaseous waste product separated out for disposal. In this respect it is to be noted that such catalytic oxidiser is required to act upon volatile organic compounds which have been dehalogenated by virtue of reaction (producing silver halide) with the silver ions in the electrolyte and is also required to act in a high NOₓ environment.

It is necessary to compensate for transfer of silver, water and organic molecules from anolyte to catholyte in the electrochemical cell. This is conveniently achieved by extracting a proportion of catholyte for feeding into the anolyte. To help reduce any tendency for build-up of solids in the catholyte, the said extracted catholyte is subject to a solids concentration process, a high solids fraction being fed into the anolyte and a low solids fraction being returned to the catholyte.

By applying cooling to the extracted catholyte prior to subjection to the solids concentration process, precipitation of dissolved organic matter is encouraged thereby to enhance the return to the anolyte of organic matter which has not yet been destroyed.

To deal with build-up of unwanted matter in the electrolyte, a proportion of anolyte is extracted, treated to separate unwanted matter and product depleted in unwanted matter is fed back to the electrochemical cell as catholyte. This arrangement in which the feed of electrolyte depleted in unwanted matter is fed back to the catholyte, rather than to the anolyte from which the feed was initially taken, offers an added advantage in that it enables the feed from catholyte to anolyte (referred to above for compensating for the transfer of silver, water and organic molecules from anolyte to catholyte in the electrochemical cell) to be increased and thereby lower the equilibrium concentrations of organic matter and silver in the catholyte.

The separation of unwanted matter from the extracted portion of the anolyte is carried out using precipitation, crystallisation, distillation, membrane separation as by filtration or electrodialysis, absorption, solvent extraction, or steam stripping (for example using a gas liquid contactor such as described in GB 2 282 983) the steam (gas) carrying the stripped out matter (typically volatile organic matter) being then condensed and returned to the anolyte.

Preferably, waste matter is subjected to high shear mixing with the anolyte in a vessel separate from the electrochemical cell, anolyte being circulated between the said vessel and the electrochemical cell. Alternatively or additionally the waste matter may be shredded prior to mixing with the anolyte, and/or subjected in the said vessel to insonation with high energy ultrasound.

Preferably, feed of anolyte from the said vessel to the electrochemical cell is via a solids concentration process, a high-solids fraction being returned to the vessel and a low Solids fraction passing to the electrochemical cell.

Insoluble waste matter is conveniently supplied as a slurry of solids suspended in water. If the waste matter is explosive, it may be necessary to ensure that the water content of the slurry is maintained at or above a specified percentage. To reduce the water burden introduced into the electrolyte, such a feed is preferably subjected to a solids concentration process just prior to mixing with anolyte, a high solids fraction being fed into the anolyte and mixed therewith. This may be acceptable, provided the length of the flow path for the more concentrated slurry is short. A low solids fraction is conveniently returned to plant where the slurry is prepared.

The invention provider in another of its aspects, apparatus for use in the treatment of waste matter comprising or including organic matter, which apparatus comprises an electrochemical cell having a cathode, an anode, a permeable separator between the anode and cathode forming an anode region and a cathode region within the cell, an acidic aqueous electrolyte containing ions of silver, means for mixing the waste matter continuously or periodically with anolyte from the electrochemical cell, a separate processing plant connected to withdraw anolyte continuously or periodically for treating the anolyte to remove unwanted matter and/or waste product therefrom, the said separate processing plant including means for subjecting withdrawn anolyte to a heat treatment for destroying any residual organic matter contained therein.

Preferably the acidic aqueous electrolyte comprises nitric acid and said ions of silver.

Preferably, at least one gas treatment component, for example a catalytic oxidiser which may comprise a non-thermal plasma device, for removing volatile organic compounds is connected to treat off-gas from the apparatus.

Preferably, an anolyte vessel is connected for circulation of anolyte between the anolyte vessel and the anolyte region of the electrochemical cell, a catholyte vessel is connected for circulation of catholyte between the catholyte vessel and the catholyte region of the electrochemical cell, and a connection is provided for extracting and feeding a proportion of catholyte from the catholyte vessel into the anolyte vessel to compensate for transfer of silver, water and organic molecules from anolyte to catholyte in the electrochemical cell.

Preferably, the said connection between the catholyte vessel and the anolyte vessel includes means for effecting a solids concentration process, a high solids fraction being fed into the anolyte vessel-and a low solids fraction being returned to the catholyte vessel. Increased effectiveness of the solids concentration process may be achieved by including a cooler positioned so that the said extracted catholyte is cooled prior to being subjected to said solids concentration process.

Preferably, a high shear mixer is provided for mixing the waste matter with the anolyte supplied to the anolyte vessel from the electrochemical cell, and a connection for feeding anolyte from the anolyte vessel to the electrochemical cell includes means for effecting a solids concentration process, a high solids fraction being returned to the vessel and a low solids fraction passing to the electrochemical cell. This serves to minimise transfer of solid organic matter into the electrochemical cell itself and thus reduce the risk of such matter fouling the electrochemical cell and the membrane thereof in particular.

Specific constructions of apparatus and methods embodying the invention will now be described by way of example and with reference to the drawings filed herewith, in which:

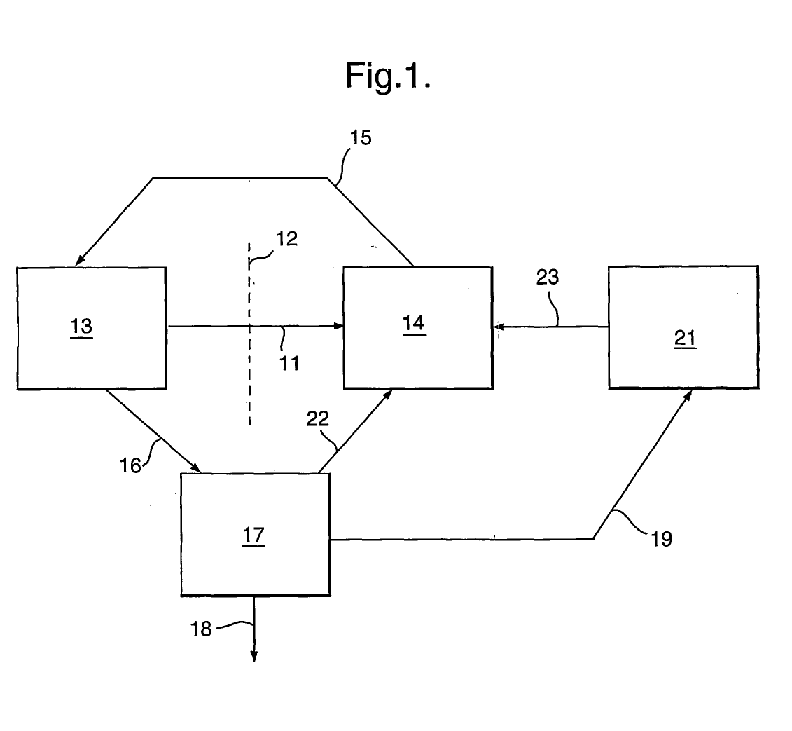

FIG. 1 is an outline schematic representation of apparatus for use in the decomposition of waste matter,

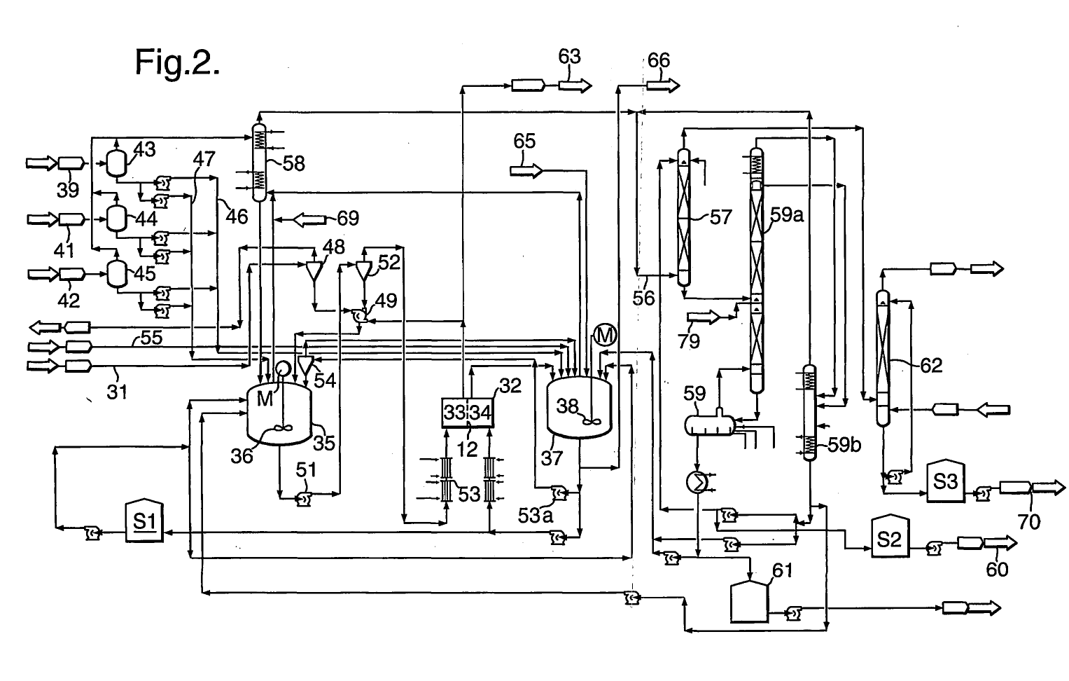

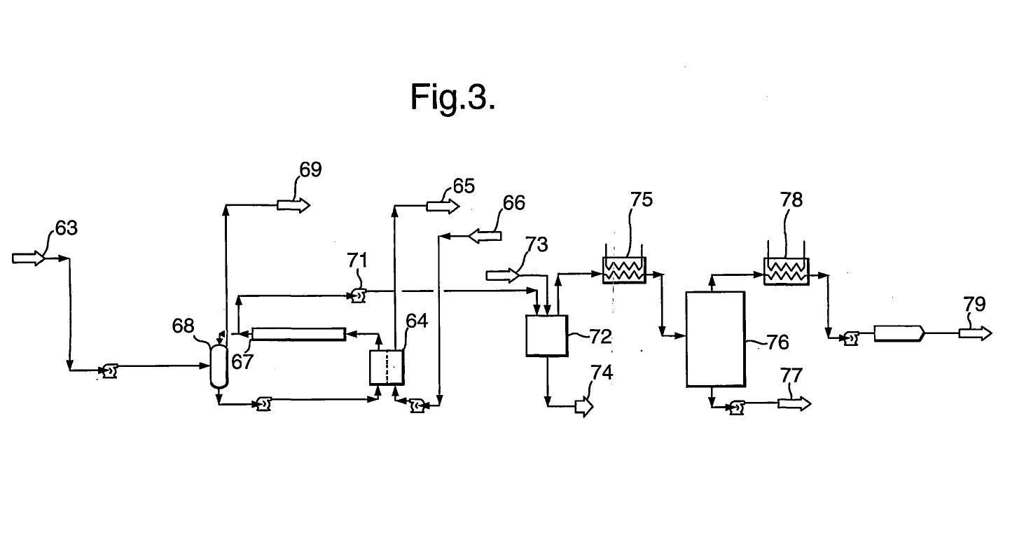

FIGS. 2 and 3 provide a schematic representation of a complete apparatus for use in the decomposition of waste matter,

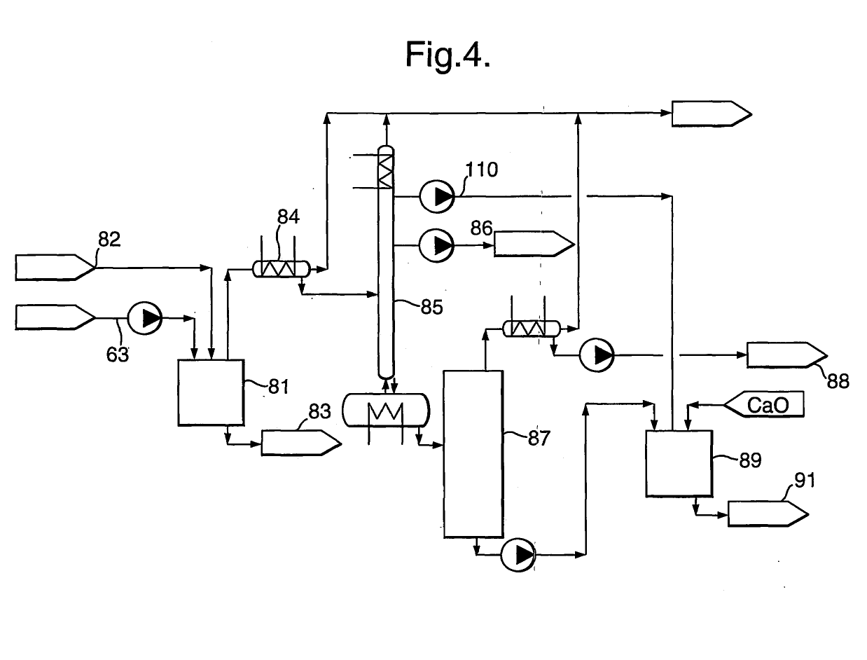

FIG. 4 is a schematic representation, corresponding to FIG. 3, of part of a modified apparatus, and

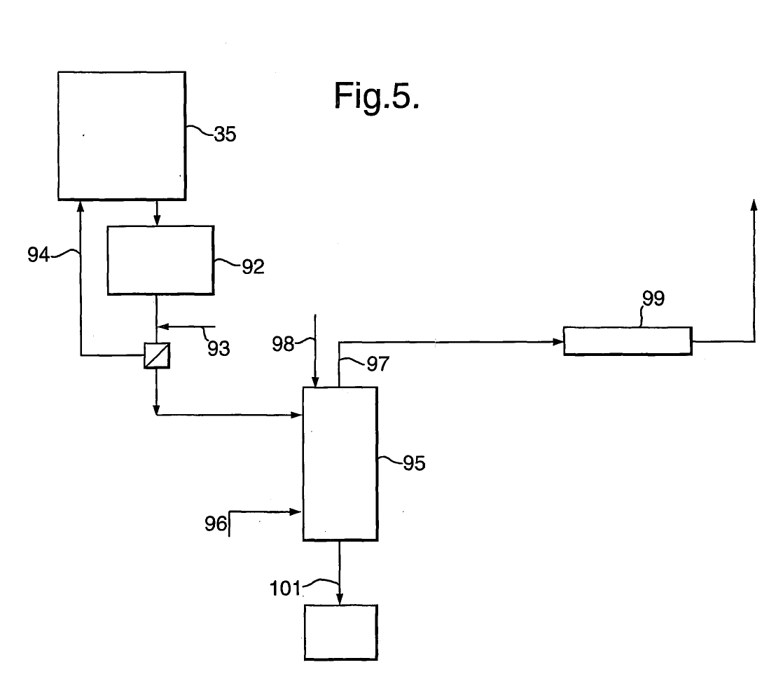

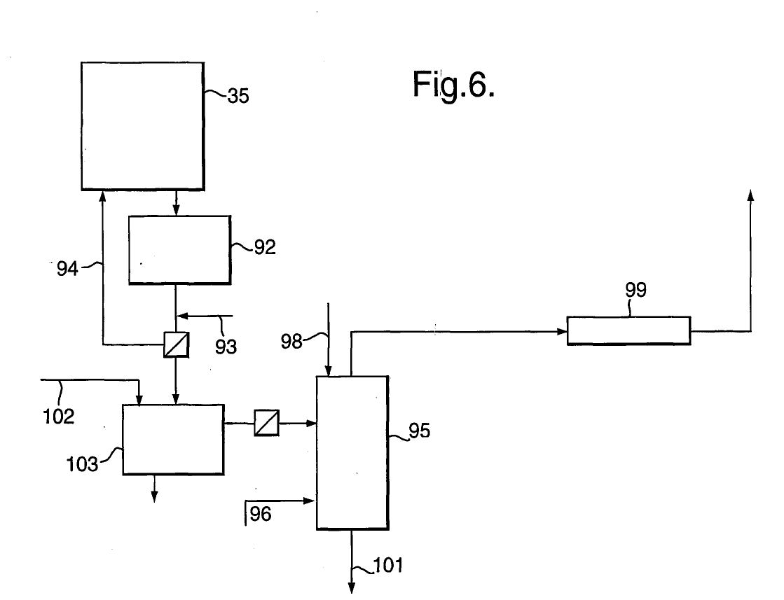

FIGS. 5 and 6 are schematic representations of′ further modifications for that part of the apparatus represented in FIG. 3 or FIG. 4.

The principle of operation of the apparatus, which is explained in EP 0 297 738 is straightforward. In an electrochemical cell, an electrolyte of nitric acid containing silver ions is separated by a membrane into an anode region and a cathode region. Waste matter to be decomposed is mixed with the anolyte. Ag++ ions in the anolyte either directly themselves or via secondary oxidising species oxidise the waste matter. The reduced Ag+ ions produced in this process are electrochemically re-generated in the cell.

The apparatus can be operated continuously, but two processes limit the period of operation before the chemistry of the electrolyte moves outside operating limits for the process. These are firstly build-up of unwanted components in the anolyte resulting from the feed of organic waste matter and secondly the transfer of silver, water and organic compounds across the membrane of the electrochemical cell from anolyte to catholyte. The unwanted components may derive from metal constituents in the waste matter feed or components of organic molecules in the waste such as sulphur, phosphorus or halogens, with fluorine presenting a particularly hazardous complication through the formation of hydrogen fluoride in the anolyte reactions. Build-up of water and nitrogen from the feed of waste matter, although not contaminants in the nitric acid chemistry of the anolyte, have to be managed by appropriate removal to maintain acceptable volumes and functional concentrations in the apparatus.

FIG. 1 shows in outline the principles of the apparatus configuration and method for dealing with these two limiting processes. Arrow 11 represents the transfer in the electrochemical cell across membrane 12 of water, silver and organic molecules from anolyte 13 to catholyte 14. To counteract this, a catholyte bleed stream 15 is taken from the catholyte 14 and fed back to the anolyte 13. To deal with build-up of unwanted components in the anolyte, an anolyte bleed stream 16 is taken from the anolyte 13 and fed to an electrolyte management system 17 which separates out unwanted contaminants for disposal at 18, removes nitrogen in the form of nitrogen oxides which pass (arrow 19) to a nitrogen oxides reformer 21. The stream, depleted in nitrate and contaminants is fed back (arrow 22) into the electrochemical cell as catholyte. Nitric acid and water from the nitrogen oxides reformer 21 can be fed back (arrow 23) to the catholyte 14, but excess is removed from the system for use elsewhere.

FIGS. 2 and 3 show a specific detailed apparatus designed for handling organic waste supplied at 31 as a slurry with excess water, such as may be required when the waste is explosive.

The heart of the apparatus is electrochemical cell 32 having an anolyte region 33 and catholyte region 34 separated by membrane 12. A main reaction anolyte vessel 35 having a stirrer 36 is supplied with anolyte (thus held separately from the anolyte region 33 of the electrochemical cell 32) and other process streams as will be described below. A catholyte vessel 37, also provided with a stirrer 38, provides a holding and management vessel for catholyte separate from the catholyte region 34 of the electrochemical cell 32.

Electrolyte supply for the anolyte vessel 35 and catholyte vessel 37 at startup and for any makeup required during processing is provided from a supply 39 of silver nitrate solution, a supply 41 of nitric acid and a supply 42 of process water. Each of these supplies has a respective storage tank 43, 44, 45 from which pumps provide controllable feed through line 46 to the catholyte vessel 37 and line 47 to the anolyte vessel 35.

Feed, in this example, of a slurry in water of organic waste at 31 passes first to hydrocyclone 48 from which a solids rich component passes via fluidic vortex mixer 49 to the anolyte vessel 35. The light fraction (mainly water) from the hydrocyclone 48 is returned to a slurrying plant (not shown) where the feed supply is prepared. The oxidation reactions driven by Ag++ ions take place in the anolyte vessel 35, with corresponding reduction of Ag++ to Ag+. A flow of anolyte from the anolyte vessel 35 to the electrochemical cell 32, where re-generation of Ag+ to Ag++ takes place, is driven by a pump 51 via hydrocyclone 52. Solids in this flow are separated out in the hydrocyclone 52 and returned via fluidic vortex mixer 49 to the anolyte vessel 35, while the solution containing Ag+ ions for regeneration pass via heat exchanger 53 to the anolyte region 33 of the electrochemical cell 12. Anolyte containing re-generated Ag++ is returned from the anolyte region 33 to the anolyte vessel 35 via fluidic vortex mixer 49. In this way, the electrochemical cell 32 is protected from exposure to quantities of solids which would tend to foul the membrane 12.

A pump 53a provides a controlled bleed of catholyte from the catholyte vessel 37 to hydrocyclone 54, which separates the bleed stream into a solids rich component passed into the anolyte vessel 35 and a solids depleted component returned to the catholyte vessel 37. By applying cooling to this bleed stream from the catholyte vessel 37, sparingly soluble organic matter in solution is encouraged to precipitate out, thus further reducing concentration of organic matter in the catholyte. The flow rate is controlled so that the volumetric return to the anolyte vessel matches the volumetric transfer of water, silver and organic molecules across the membrane 12 from anolyte to catholyte.

A supply of oxygen at 55, for the nitrogen oxides reformer, is fed to the catholyte vessel 37 where it mixes with the off-gas taken from the catholyte vessel 37, and also from the anolyte vessel 35, ultimately feeding at 56 to absorption column 57 of the nitrogen oxides reformer. This off-gas first passes through a two stage chiller 58, the first stage of which, at 2° C. condenses water vapour and the second stage, at −10° C., removes condensable volatile organic compounds. The condensates are returned to the anolyte vessel 35. Any off-gas from the storage tanks 43,44,45, which may contain nitrogen oxides, joins the off-gas stream at this point.

The nitrogen oxides reformer operates in a conventional manner with boiler 59 feeding a fractional distillation column 59a. The NOₓ and O₂-laden gas enters at the base of absorption column 57 where it is brought into contact with a stream of cool, dilute nitric acid (typically ˜1% in H₂O) running down from the top of the column. The gas stream will become progressively depleted of NO, as it passes up the column, whereas the liquid stream will accumulate nitric acid as it passes down the column. The gas stream exits the top of column 57 and passes to the next treatment step, being a caustic scrubber 62 containing for example an oxidising agent such as sodium hypochlorite or dilute nitric acid dosed with hydrogen peroxide. The liquid stream drains from the base of absorption column 57 into distillation column 59a. The acid concentration in the distillation column 59a will be close to the azeotrope (˜68 wt %), and in the top of the column typically less than 1% although these figures may vary according to the design and operation of the column. The concentration in the top of the column can be regulated by adjusting the quantity of distillate drawn from the top of the column and hence the reflux fraction. The dilute distillate is cooled in cooler 59b and a proportion is pumped to the top of absorption column 57, forming the aforementioned dilute acid stream. The balance of the distillate and the concentrated acid in the bottoms can both be used elsewhere in the process to replenish electrolytes or feed streams. Thus nitric acid is drawn off from the boiler 59 for electrolyte makeup by supply to catholyte vessel 37, if required, otherwise to storage tank 61 from which excess nitric acid may be supplied as a by-product. Similarly dilute nitric acid from the cooler 59b can be supplied if required to the catholyte vessel 37 and/or the anolyte vessel 35. Effluent gas from three scrubber 62 may have a residual content of volatile organic compounds and, to remove these, is therefore fed to a catalytic oxidiser (not shown).

For removal of unwanted matter build-up in the anolyte, a bleed stream is taken at 63 and fed first (see FIG. 3) to a supplementary eleectrochemical cell 64 to remove as much as possible of residual organic matter in the stream. Catholyte for the supplementary electrochemical cell 64 is circulated from the main catholyte vessel 37 via pipelines marked 65, 66 in both FIGS. 2 and 3. Anolyte is circulated through the anolyte region of electrochemical cell 64, a plug flow reactor 67, and supplementary anolyte vessel 68. The plug flow reactor may comprise a plurality of anolyte vessels connected in series off-gas from the supplementary anolyte vessel 68 communicates via pipeline 69 with the anolyte head space of anolyte vessel 35.

The stream, now further depleted in organic matter, is driven by pump 71 to an apparatus 72 in which it is first mixed with hydrochloric acid supplied on pipeline 73 to precipitate Ag as silver chloride for recovery. The silver chloride separated (by settlement, filtration or hydrocyclone) is first subjected to heat treatment at 518° C. for at least 15 minutes to remove any residual organic matter precipitated therewith and then removed as indicated at 74 for reclamation. The supernatent together with vapour driven off by the heat treatment is passed via condenser 75 (to condense the vapour) to an evaporator 76 which concentrates non-volatile impurities such as metals, sulphates and phosphates. The concentrate is removed for storage/disposal at 77. Addition of calcium oxide stabilises any sulphuric acid and phosphoric acid in the effluent to decomposition as calcium sulphate and calcium phosphate solids which can be disposed to land-fill. The distillate of nitric acid condensed at 78 is returned to the main plant via 79 to the fractional distillation column 59a. This route provides effectively for a return into the catholyte vessel 37 of the anolyte bleed stream after removal of unwanted matter therefrom.

An alternative approach for the reclamation of the silver after precipitation, which takes advantage of the heat treatment for removal of residual organic matter, is to add caustic soda which reacts with the silver chloride at the high temperature (>600° C.) with evolution of oxygen, from which reaction, after cooling, there is produced a dispersion of silver metal in sodium chloride. The sodium chloride can be leached out with water and the silver metal recovered therefrom by settling, hydrocyclone or filtration and returned to the anolyte vessel 35 directly or as silver nitrate after dissolution in nitric acid. The sodium chloride can be treated to recover caustic soda for recycling.

In a further alternative approach, the silver chloride precipitate can be directly converted to silver metal and sodium chloride by contact with base (eg NaOH) and a reducing agent. The reducing agent may be a chemical reducing agent (eg hydrogen peroxide, formaldehyde), or electrochemical. Thus, for example, a porous cathode (eg a high surface area carbon felt) can be used as a filter to capture suspended silver chloride precipitate. The cell would then be taken off-line and the catholyte changed to a caustic solution. During the passage of the current, the reaction at the cathode:

e⁻⁺AgCl+NaOH→Ag+NaCl+OH⁻ takes place

converting the precipitate to adherent silver metal deposit. Oxygen is evolved from the anode—eg from a precious metal coated electrode also in caustic.

After draining, acid solution can be passed through the unpowered cell to dissolve the silver metal to give silver nitrate for return to the anolyte. NOₓ released is passed to the NOₓ reformer 56.

If a cation membrane divided cell is used, a Ni anode can be used in NaOH electrolyte.

The function of the storage tank S1 is to provide a repository when required for catholyte for maintenance or process operating requirements. Storage tank S2 is an intermediate holding vessel for dilute nitric acid from the nitrogen oxides reformer in passage via 60 to more permanent dilute acid storage. Rather than disposing of dilute nitric acid as a waste stream, the dilute nitric acid can be treated by electrochemical ion exchange to produce concentrated nitric acid for recycling in the apparatus and water, which can also be recycled.

Storage tank S3 is for temporary storage of waste from the nitrogen oxides scrubber 62 in passage via 70 to a caustic reclamation plant. The waste will contain excess sodium hydroxide, sodium chloride and sodium nitrate, which can be treated to regenerate sodium hydroxide for recycling.

FIG. 4 shows a variant of the apparatus for removing unwanted matter from the anolyte for use in dealing with forms of organic waste feed for which the use of the supplementary electrochemical cell for removing residual organic matter is considered unnecessary and the level of nitrogen in the waste is relatively low. The first stage of treatment corresponds to that described in relation to FIG. 3 for the recovery of Ag. In apparatus 81 the anolyte bleed stream 63 is mixed with hydrochloric acid from 82, the precipitated silver chloride is separated, heat treated to remove residual organic matter, and passed 83 for recovery. From a condenser 84, the supernatant is fed to fractional distillation column 85 from which nitric acid condensate is extracted at 86 for return direct to the catholyte vessel 37. The remaining solution of unwanted matter (metals, sulphates, phosphates) is concentrated in evaporator 87. Condensate from evaporator 87 is returned via 88 to the base of the nitrogen oxides reformer absorption column. Concentrate from the evaporator 87 collected at 89 is treated with lime and heated (518° C. for at least 15 minutes) to remove residual organic matter and then passed 91 for disposal.

Any hydrogen fluoride in the stream will condense out after the nitric acid in the fractionation column 85 and is carried by pipeline 110 to be reacted at 89 with lime (to produce calcium fluoride) at high temperature along with the concentrate from the evaporator 87. In addition any fluoride released into the anolyte from the mineralisation of fluorine containing organic molecules can be complexed by polyvalent cations such as Al³⁺ or Ti⁴⁺. These pass to the evaporator 87 after treatment with lime producing calcium fluoride, which is stable at the high temperature.

In the modification illustrated by FIG. 5, the anolyte bleed stream is taken directly from the anolyte vessel 35. This will contain undecomposed solid organic waste as well as unwanted compounds in solution such as of metals, sulphates and phosphates. The anolyte bleed stream is allowed to cool (from the operating temperature of about 80° C. down to ambient) and settle in vessel 92. The settled solids are subjected (as indicated at 93) to a rinse in dilute nitric acid and then returned (94) to the anolyte vessel 35. The supernatent solution then passes to heater/mixer 95 where it is mixed with formaldehyde introduced at 96 and heated to a temperature between 80° C. and 100° C. The formaldehyde reacts with nitrate in the solution to produce nitrogen oxides which are driven off at 97 from the heater/mixer 95 along with water vapour, nitric acid, and volatile organic compounds. This off-gas, mixed with oxygen fed at 98 into the head space of the heater/mixer 95, is passed to the catalytic oxidiser 99 in which residual volatile organic compounds are decomposed to carbon dioxide and water. The effluent gas from the catalytic oxidiser 99 containing nitrogen oxides, nitric acid and water along with residual oxygen is passed to the reflux column 57 of the nitrogen oxides reformer.

The solution of metals, including Ag, sulphates and phosphates from the heater/mixer 95 is passed 101 for further processing, either directly for disposal after heat treatment to remove residual organic matter, or for recovery of the Ag prior to the disposal of the remainder.

In FIG. 6, Ag recovery by precipitation with hydrochloric acid fed at 102 is carried out in apparatus 103 prior to passing the anolyte bleed solution to the heater/mixer 95. Apart from this, the components and arrangement of FIG. 6 are identical to those of FIG. 5 and accordingly bear the same reference numerals.

The invention is not restricted to the details of the foregoing examples. For instance, the anolyte vessel 35 may advantageously be provided with at least one, and in practice a plurality (eg up to 10) of, high intensity ultrasonic transducers attached around its walls and focussed to concentrate ultrasonic energy within the anolyte away from the vessel walls. By microcavitation effects, and efficient coupling of energy from the ultrasound, this serves to enhance directly the action of the oxidising species in the anolyte upon solid organic waste therein. The effective increase in interfacial area for reaction which this provides and consequent improvement in current efficiency means that a smaller plant and reduced energy consumption are achieved for an equivalent quantity of waste treated.

In the embodiments of FIG. 5 and FIG. 6, removal of nitrates need not necessarily be effected by chemical dosing, as with formaldehyde. In an alternative, the nitrates can be removed electrochemically by passing the stream through the catholyte region of an electrochemical cell, which will produce nitrogen oxides. The nitrogen oxides thus produced can be passed to the nitrogen oxides reformer where they are reformed into nitric acid either for return to the process or to be exported as substantially organic- and impurities-free product.

Where build-up of nitrate in the anolyte occurs primarily as a consequence of the bleed stream of catholyte fed back to the anolyte, it is possible to perform the denitrating process directly on this stream using either chemical dosing or electrochemical treatment to convert the nitrates to nitrogen oxides which, in turn, are passed to the nitrogen oxides reformer.

Referring to FIG. 2, the three streams fed to the fluidic vortex mixer 49 need not necessarily be mixed in this way, but may be fed directly to the anolyte vessel 35. This may, indeed, be preferable for the concentrated feed slurry of organic waste matter, where this is explosive, to minimise the path length before admixture with bulk anolyte.

The construction materials for the plant are chosen according to the nature/corrosiveness of the materials to be contained. For example the feed and anolyte containment where organic fuel is to be treated is desirably titanium, with stainless-steel for the catholyte. Alternatively PTFE/PVDF either as construction material or lining can be used for both anolyte and catholyte containment. Where halogen containing warfare agents are to be treated, then PTFE/PVDF either as construction material or lining is required.

The examples described above illustrate use of a catalytic oxidiser to remove volatile organic compounds. However, it may be necessary to position catalytic oxidisers for removing volatile organic compounds ahead of distillation or reformer components to avoid the possibility of such compounds condensing and fouling these components. In particular the positioning of a catalytic or non-thermal plasma oxidising reactor (or a combined catalytic non-thermal plasma reactor) in the line 56 just upstream of the absorber column 57 offers the added advantage that, in addition to oxidation of volatile organic compounds, there will be oxidation of nitrogen oxides to NO₂, thus assisting the function of the nitrogen oxides reformer.

An alternative to the use of a catalytic oxidiser for removal of volatile organic compounds that have not been trapped by condensation and return for further oxidation treatment in anolyte (eg in the main anolyte vessel 35), it is possible to subject the effluent gas to scrubbing with anolyte liquor comprising Ag²⁺ in nitric acid. A gas/liquid contactor of the type described in patent GB 2282983 is particularly suitable as such a scrubber.

As an alternative to the supplementary electrochemical cell in FIG. 3 for destruction of residual organic matter in the anolyte bleed stream, such residual organic matter could be recovered by solvent extraction in a low volatility immiscible solvent (e.g. kerosene). This organic solution could be fed back to the anolyte vessel 35. Contact could be by vortex mixer with separation by gravity, mesh coalescor or hydrocyclone. A further alternative is to absorb the residual organic matter selectively on a sorption matrix (e.g. cellulose), which also could be returned to the anolyte vessel 35.

The gaseous effluent from the scrubber 62, after treatment in a catalytic oxidiser, may as a final precaution be filtered through activated charcoal; When spent, the charcoal may be disposed of directly by feeding to the anolyte vessel 35. Alternatively, the spent charcoal may be re-activated by exposure to steam at high temperature (518° C.) which will strip out organic matter trapped by the activated charcoal. After condensation, the steam, along with stripped out organic matter, is returned to the anolyte vessel 35.

In order to reduce the amount of NOₓ released from the catholyte region 34 through reduction of HNO₃, oxygen injection could be provided via a gas/liquid mixer positioned downstream of a recirculation pump returning decontaminated catholyte liquor to the catholyte region 34. Oxygen provided in this way is immediately available to re-oxidise HNO₂ to HNO₃ without NOₓ formation—thus reducing the burden on the NOₓ reformer—and hence reducing size and cost of the apparatus.

As an alternative to the NOₓ reformer, NOₓ can be removed by scrubbing with hydrogen peroxide which converts the NOₓ gases directly to HNO₃. The effectiveness of hydrogen peroxide as scrub liquor for this purpose declines with decreasing NOₓ concentration. A counter-current multi-stage system is therefore desirable for which a multi-stage series of gas/liquid contactors as described in patent GB2282983 is particularly suitable. The final scrub liquor can be extracted as nitric acid for recycle. The hydrogen peroxide required may be generated on site by an electrochemical process such as is described in patent specification GB 01 29191.3 filed Dec. 6, 2001.

Whilst nitric acid is the preferred acid to couple with silver ions for the electrolyte, it is possible to use methanesulphonic acid. The silver salt is very soluble and excess water can be removed by simple distillation.

A number of precautions are desirable for protecting the anode. Specifically:

(a) if the cell potential is allowed to rise too high, oxidation of a titanium anode may occur. Care is therefore needed to avoid exceeding a cell potential of 2.5 volts. Alternatively, the problem may be eased by using an alloy of titanium with niobium and possibly IrO₂/Nb/Ti, which would raise the voltage at which oxidation of the anode would occur.

(b) the presence of fluoride can cause corrosion of an anode coated with platinum through pin-hole flaws in the coating. Care is thus needed to achieve flaw free coating. Alternatively, inclusion of complexants such as Al, Ti, (Si,B) in solution will “tie up” the fluoride, reducing corrosivity towards the electrode.

1. A method of treating waste matter comprising organic matter in which method an acidic aqueous electrolyte (13,14) containing ions of silver as an electrochemically re-generable primary oxidising species is subjected to an electric potential within an electrochemical cell (32) and the waste matter is added to the electrolyte (13) either continuously or periodically thereby to be decomposed by an oxidation process in which the primary oxidising species is reduced and re-generated by the electric potentials characterieed in that electrolyte is withdrawn for separation of unwanted matter and/or waste product therefrom and a treatment is applied which removes residual organic matter from the-said unwanted matter and/or waste product.

2. A method as claimed in claim 1, wherein treatment is provided for removing volatile organic compounds from any gaseous matter withdrawn.

3. A method as claimed in claim 2, wherein raid gaseous matter is passed through a catalytic oxidiser for removing volatile organic compounds therefrom.

4. A method as claimed in claim 1 or 2, wherein the said treatment is a heat treatment carried out at at least 518° C. for a period of at least 15 minutes.

5. A method as claimed in any of the preceding claims, wherein the acidic aqueous electrolyte (13,14) comprises nitric acid and said ions of silver.

6. A method as claimed in any of the preceding claims; wherein a proportion of catholyte (14) is extracted for feed in to the anolyte (13) to compensate for transfer of silver, water and organic molecules from anolyte (13) to catholyte (14) in the electrochemical cell.

7. A method as claimed in claim 6, wherein said concentration process, a high solids fraction being fed into the anolyte (13) and a low solids fraction being returned to the catholyte (14).

8. A method as claimed in claim 7, wherein said extracted catholyte (14) is cooled prior to being subjected to said solids concentration process, the cooling encouraging precipitation of dissolved organic matter thereby to enhance the return of organic matter to the anolyte (13).

9. A method as claimed in any of the preceding claims, wherein, to deal with build-up of unwanted matter in the electrolyte (13, 14), a proportion of anolyte-(13) is extracted, treated to separate unwanted-matter and product depleted in unwanted matter is fed back to the electrochemical cell as catholyte (14).

10. A method as claimed in claim 9, wherein the separation of the-unwanted matter is carried out by precipitation, crystallization distillation, membrane separation as by filtration or electrodialysis, absorption, solvent extraction, or Steam stripping.

11. A method as claimed in any of the preceding claim, wherein solid waste matter is subjected to high shear mixing with the anolyte (13) in an anolyte vessel (35) separate from the electrochemical cell (32), anolyte (13) being circulated between the said anolyte vessel (35) and the electrochemical cell (32).

12. A method as claimed in claim 11, wherein feed of anolyte (13) from the said vessel (35) to the electrochemical cell (32) is via a solids concentration process, a high solids fraction being returned to the vessel (35) and a low solids fraction passing to the electrochemical cell (32).

13. A method as claimed in any of the preceding claims, wherein waste matter mixed with the anolyte (13) in an anolyte vessel (35) is subjected to insonation with ultrasound.

14. A method as claimed in any of the preceding claims, wherein waste matter is supplied as a slurry of solids suspended in water and is subjected to a solids concentration process just prior to mixing with anolyte (13), the high solids fraction being fed into she anolyte (13) and mixed therewith.

15. Apparatus for use in the treatment of waste matter comprising or including organic matter, which apparatus comprises an electrochemical cell (32) having a cathode, an anode, a permeable separator (12) between the anode and cathode forming an anode region (33) and a cathode region (34) within the cell, an acidic aqueous electrolyte (13,14) containing ions of silver, means for mixing waste matter continuously or periodically with anolyte (13) from the electrochemical cell (32), a separate processing plant (FIG. 3) connected (63) to withdraw anolyte (13) continuously or periodically for treating the anolyte (13) to remove unwanted matter and/or waste product therefrom, the said separate processing plant including means (72) for applying a heat treatment for destroying any residual organic matter contained therein.

16. Apparatus as claimed in claim 15, wherein the acidic aqueous electrolyte (13,14) comprises nitric acid and said ions of silver.

17. Apparatus as claimed in claim 15 or 16, wherein at least one gas treatment component for removing volatile organic compounds is connected to treat off-gas from the apparatus.

18. Apparatus as claimed in claimed 17, wherein the said gas treatment component comprises a catalytic oxidiser.

19. Apparatus as claimed in any of claims 15 to 18, wherein an anolyte vessel is connected for circulation of anolyte between the anolyte vessel and the anolyte region of the electrochemical cell, a catholyte vessel is connected for circulation of catholyte between the catholyte vessel and the catholyte region of the electrochemical cell, and a connection is provided for extracting and feeding a proportion of catholyte from the catholyte vessel into the anolyte vessel to compensate for transfer of silver, water and organic molecules from anolyte to catholyte in the electrochemical cell.

20. Apparatus as claimed in claim 19, wherein the said connection between the catholyte vessel and the anolyte vessel includes means for effecting a solids concentration process, a high solids fraction being fed into the anolyte vessel and a low solids fraction being returned to the catholyte vessel.

21. Apparatus as claimed in claim 20, wherein the said connection between the catholyte vessel and the anolyte vessel further includes a cooler positioned so that the said extracted catholyte is cooled prior to being subjected to said solids concentration process.

22. Apparatus as claimed in any of claims 19 to 21, wherein a connection is provided for feeding anolyte, from which unwanted matter has been separated, back to the catholyte vessel.

23. Apparatus as claimed in any of claims 19 to 22, wherein a high shear mixer is provided for mixing the waste matter with the anolyte supplied to the anolyte vessel from the electrochemical cell.

24. Apparatus as claimed in claim 23, wherein a connection for feeding analyte from the anolyte vessel to the electrochemical cell includes means for effecting a solids concentration process, a high solids fraction being returned to the vessel and a low solids fraction passing to the electrochemical cell.

25. Apparatus as claimed in any of claims 19 to 24, wherein waste matter is supplied as a slurry of solids suspended in water and a connection for supplying the slurry to the anolyte vessel includes means for effecting a solids concentration process just prior to the anolyte vessel, a high solids fraction being fed into the anolyte vessel.

26. Apparatus as claimed in any of claims 15 to 25, wherein ultrasonic transducers are connected to insonate waste matter mixed with the anolyte (13) to enhance the reaction of oxidising species in the anolyte (13) with the waste matter.
